(19) United States
(12) Patent Application Publication
(10) Pub. No.: US 2025/0323379 A1
(43) Pub. Date: Oct. 16, 2025

(54) POWER STORAGE DEVICE

(71) Applicant: TOYOTA JIDOSHA KABUSHIKI KAISHA, Toyota-shi (JP)

(72) Inventor: Shinya Goitsuka, Nisshin-shi (JP)

(73) Assignee: TOYOTA JIDOSHA KABUSHIKI KAISHA, Toyota-shi (JP)

(21) Appl. No.: 19/072,098

(22) Filed: Mar. 6, 2025

(30) Foreign Application Priority Data
Apr. 15, 2024 (JP) 2024-065548

(51) Int. Cl. H01M 50/367; H01M 50/249; H01M 50/289

(52) U.S. Cl. CPC H01M 50/367; H01M 50/249; H01M 50/289; H01M 2220/20

(57) ABSTRACT

The power storage device includes a power storage module including a lower surface on which an exhaust hole is formed, a lower case including a bottom surface portion covering a lower surface of the power storage module from below, and a cross member (partition member) provided in the lower case so as to partition a region in which the power storage module is disposed in the lower case. A groove portion (recessed portion) recessed downward is formed in the bottom surface portion. A flue gas path communicating with the groove portion is formed inside the cross member.

### CROSS-REFERENCE TO RELATED APPLICATION

This application claims priority to Japanese Patent Application No. 2024-065548 filed on Apr. 15, 2024, incorporated herein by reference in its entirety.

### BACKGROUND

### 1. Technical Field

The present disclosure relates to a power storage device.

### 2. Description of Related Art

WO 2020/026973 discloses a battery pack housed in a pack case. The battery pack includes a plurality of stacked batteries. WO 2020/026973 describes an example in which gas is discharged downward from a valve portion provided at a lower portion of each battery.

### SUMMARY

It is conceivable that when the gas is discharged downward from the battery as described above, foreign matter (debris) may be stuck between the pack case (lower case) and the battery pack (power storage module). In this case, the exhaust of gas and smoke from the battery pack is hindered by the foreign matter.

The present disclosure has been made in order to address the above issue, and has an object to provide a power storage device capable of suppressing the exhaust of a power storage module that discharges gas and smoke downward being hindered by foreign matter (debris).

An aspect of the present disclosure provides a power storage device including:
a power storage module including a lower surface with an exhaust hole;
a lower case including a bottom surface portion that covers the lower surface of the power storage module from below; and
a partition member provided on the lower case so as to partition a region in which the power storage module is disposed in the lower case.

The bottom surface portion is provided with a recessed portion recessed downward. A flue gas path that communicates with the recessed portion is provided inside the partition member.

In the power storage device according to the aspect of the present disclosure, as described above, a recessed portion recessed downward is formed in the bottom surface portion of the lower case, and a flue gas path that communicates with the recessed portion is formed inside the partition member. Accordingly, the gas and the smoke discharged from an exhaust port provided in the lower surface of the power storage module are discharged to the recessed portion that communicates with the flue gas path inside the partition member. As a result, the gas and the smoke can be easily directed to the flue gas path. Accordingly, it is possible to suppress foreign matter (debris) due to the gas and the smoke being deposited under the power storage module. As a result, it is possible to suppress the exhaust of the power storage module that discharges the gas and the smoke downward being hindered by the foreign matter (debris).

The partition member may be configured to:
include a lower end portion provided with an opening portion that communicates with the flue gas path; and
be disposed above the recessed portion such that the opening portion faces the recessed portion in an up-down direction. With such a configuration, the gas and the smoke discharged from the power storage module to the recessed portion can be easily caused to flow to the interior (flue gas path) of the partition member through the opening portion.

The power storage device may further include a fixing member that fixes the power storage module to the partition member.

The power storage module may be provided such that the lower surface is separated from the bottom surface portion of the lower case in a state in which the power storage module is fixed to the partition member by the fixing member.

With such a configuration, a space is formed between the bottom surface portion of the lower case and the power storage module in a state of being fixed to the partition member by the fixing member. Therefore, the flow path for the gas and the smoke discharged downward from the power storage module can be increased by the space. As a result, the gas and the smoke can be discharged more efficiently. The language “the power storage module is fixed to the partition member by the fixing member” also includes the power storage module being indirectly fixed to the partition member by the fixing member.

The power storage module may include a first power storage module, a second power storage module, and a third power storage module arranged in an arrangement direction.

The second power storage module may be disposed on one side in the arrangement direction with respect to the first power storage module.

The third power storage module may be disposed on the other side in the arrangement direction with respect to the first power storage module.

The partition member may include
a first partition member provided between the first power storage module and the second power storage module so as to extend in an intersecting direction intersecting the arrangement direction, and
a second partition member provided between the first power storage module and the third power storage module so as to extend in the intersecting direction.

The recessed portion may include a first groove portion provided to extend in the arrangement direction so as to connect the first partition member and the second partition member.

With such a configuration, the gas and the smoke discharged from the first power storage module can be guided by the first groove portion to each of the flue gas path in the first partition member and the flue gas path in the second partition member. As a result, the gas and the smoke can be discharged more efficiently than when the first groove portion is in communication with only one of the flue gas path in the first partition member and the flue gas path in the second partition member.

The recessed portion may further include a second groove portion provided below the second power storage module so as to extend in the arrangement direction, and a third groove portion provided below the third power storage module so as to extend in the arrangement direction. The first groove portion may be separated from the second groove portion and the third groove portion. With such a configuration, it is possible to suppress the gas and the smoke discharged from the first power storage module to the first groove portion flowing through the second groove portion and the third groove portion. As a result, it is possible to suppress the occurrence of a thermal chain between the power storage modules arranged in the arrangement direction.

According to the present disclosure, it is possible to suppress the exhaust of a power storage module that discharges gas and smoke downward being hindered by foreign matter (debris).

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a power storage device and a frame member according to an embodiment;

FIG. 2 is a plan view illustrating a configuration of a power storage device according to an embodiment;

FIG. 3 is a schematic cross-sectional view taken along III-III line of FIG. 2;
FIG. 4 is a schematic cross-sectional view taken along IV-IV line of FIG. 2;
FIG. 5 is a cross-sectional view taken along V-V line of FIG. 2; and
FIG. 6 is a plan view illustrating a configuration of a power storage device according to a modification of the embodiment.

### DETAILED DESCRIPTION OF EMBODIMENTS

Embodiments of the present disclosure will be described with reference to the drawings. In the drawings referred to below, the same or corresponding members are denoted by the same reference numerals.

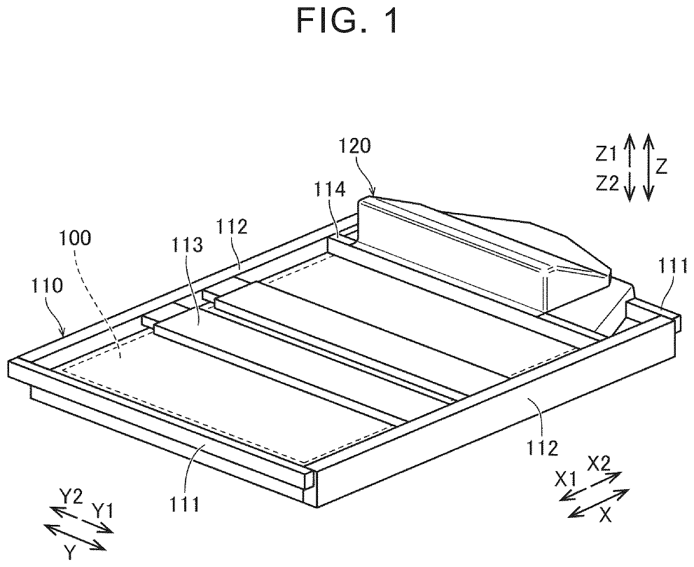

Referring to FIGS. 1 to 5, a power storage device 100 according to an embodiment of the present disclosure will be described. FIG. 1 is a perspective view illustrating a power storage device 100 according to the present embodiment. In FIG. 1, the power storage device 100 is attached to a frame member 110 disposed at the bottom of a vehicle (not shown). Examples of vehicles on which the power storage device 100 is mounted include hybrid electric vehicle (Hybrid Electric Vehicle), plug-in hybrid electric vehicle (Plug-in Hybrid Electric Vehicle), and battery electric vehicle (Battery Electric Vehicle). Note that the use of the power storage device 100 is not limited to the vehicle use.

Note that the X direction, the Y direction, and the Z direction in this specification are directions orthogonal to each other. For example, the X direction and the Y direction are the front-rear direction and the vehicle width direction of the vehicle when the power storage device 100 is mounted on the vehicle. X1 and X2 directions are vehicle front and vehicle rear, respectively. Y1 direction and Y2 direction are the vehicle left side and the vehicle right side, respectively. Further, the Z direction is an up-down (vertical) direction. Note that the X direction and the Y direction are examples of the “arrangement direction” 10 and the “intersection direction” of the present disclosure, respectively.

As illustrated in FIG. 1, the frame member 110 includes a pair of first frames 111, a pair of second frames 112, a first cross frame 113, and a second cross frame 114.

In FIG. 1, the device unit 120 is disposed on an end portion of the power storage device 100 on the rear side (X2 side). The device unit 120 is electrically connected 15 to the power storage device 100, and includes a junction box, a power supplying unit (Electricity Supply Unit), an electronic control unit (Electronic Control Unit), and the like (both not shown). Note that the arrangement position of the device unit 120 is not limited to this example.

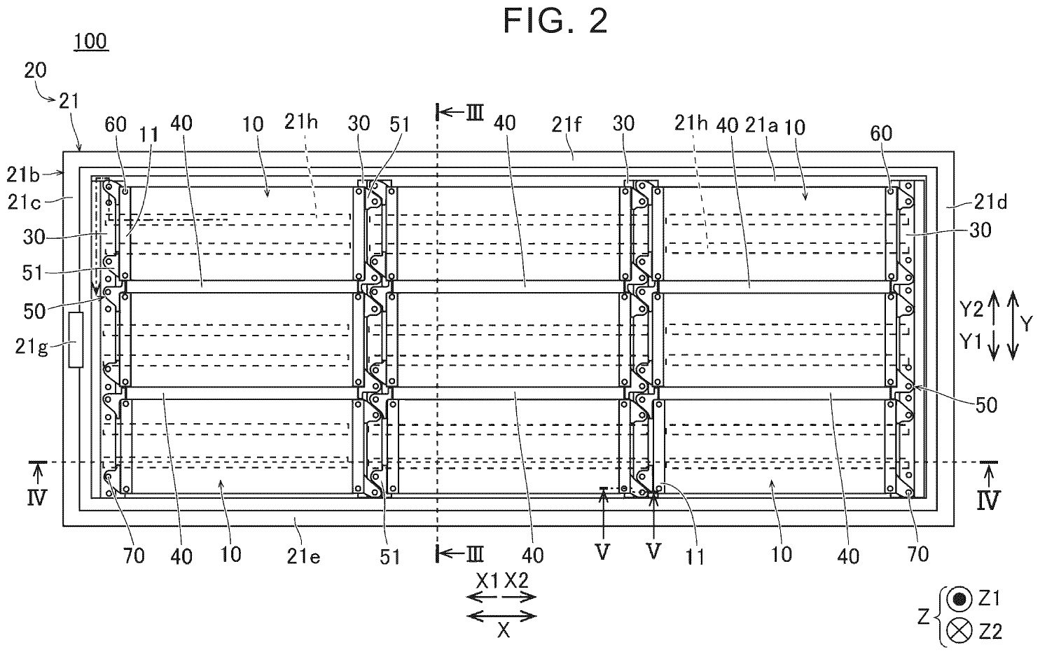

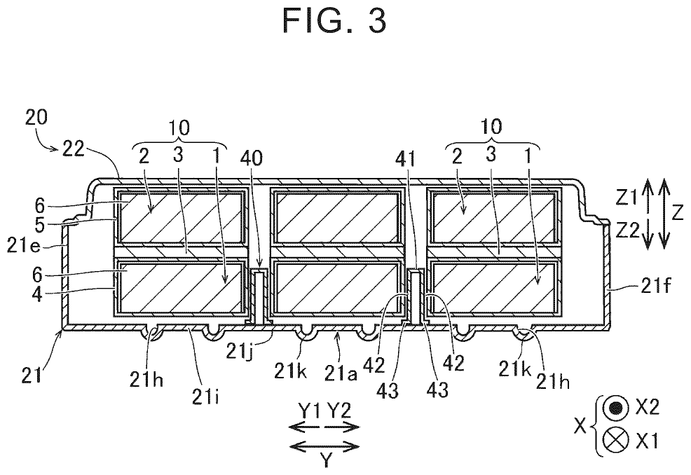

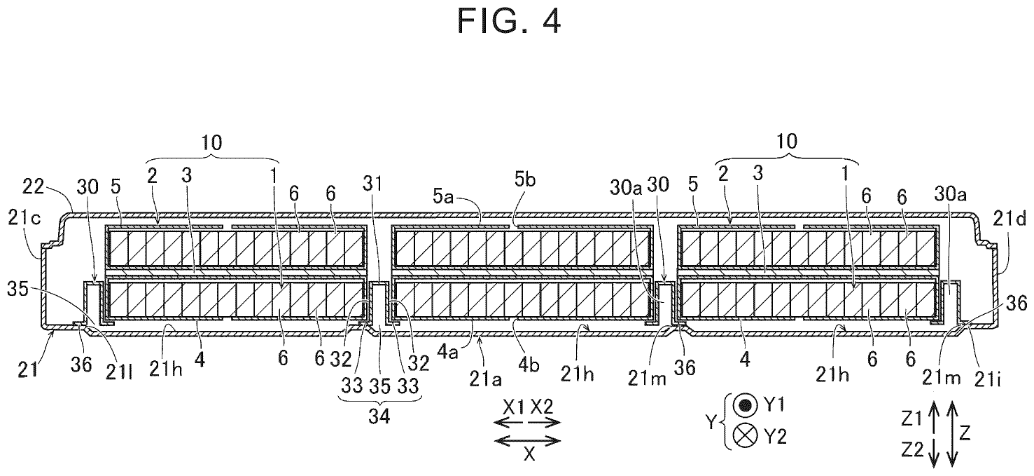

FIG. 2 is a plan view of the power storage device 100. The power storage 20 device 100 includes a plurality of power storage modules 10, a case 20, a plurality (four in the present embodiment) of cross members 30, a plurality (six in the present embodiment) of cross members 40, a plurality (six in the present embodiment) of coupling brackets 50, a plurality of bolts 60, and a plurality of bolts 70. The case 20 houses a plurality of power storage modules 10. The cross member 30 is an example of a “partition member” of the 25 present disclosure. Each of the bolt 60 and the bolt 70 is an example of a “fixing member” of the present disclosure. Further, in FIG. 2, a groove portion 21h described later is shown by a broken line.

The plurality of power storage modules 10 are arranged in a matrix (3×3) in XY plane when viewed from Z1. Specifically, three sets of the power storage modules 10 arranged in the X direction are arranged in three sets in the Y direction.

The case 20 includes a lower case 21. The lower case 21 is provided so as to cover the plurality of power storage modules 10 from below.

The lower case 21 has a bottom surface portion 21a and a peripheral wall portion 21b. The bottom surface portion 21a is provided below the plurality of power storage modules 10. The bottom surface portion 21a is provided so as to cover the plurality of power storage modules 10 from below.

The peripheral wall portion 21b is provided so as to extend Z1 from an outer peripheral edge portion of the bottom surface portion 21a. The peripheral wall portion 21b is annularly provided so as to surround the plurality of power storage modules 10.

The peripheral wall portion 21b includes a side wall 21c, a side wall 21d, a side wall 21e, and a side wall 21f. The side wall 21c is provided so as to extend in the Y- direction on the X1 sides of the plurality of power storage modules 10. The side wall 21d is provided so as to extend in the Y-direction on the X2 side of the plurality of power storage modules 10. The side wall 21e is provided so as to extend in the X-direction Y1 of the plurality of power storage modules 10. The side wall 21f is arranged so as to extend in the X-direction Y2 of the plurality of power storage modules 10.

The side wall 21c is provided with a relief valve 21g. The relief valve 21g discharges the gases and smoke discharged from the power storage module 10 into the case 20 to the outside of the case 20. The relief valve 21g opens when the pressure in the case 20 exceeds a certain level.

The cross member 30 and the cross member 40 extend perpendicularly to each other. The plurality of cross members 30 and the plurality of cross members 40 are provided to define a region in the lower case 21 where the power storage module 10 is disposed. Specifically, nine partitioned regions are formed by the plurality of cross members 30 and the plurality of cross members 40. The power storage module 10 is disposed in each of the nine regions. Each of the plurality of cross members 30 and the plurality of cross members 40 is provided in the lower case 21 (for example, fixed by welding or the like). The cross member 30 and the cross member 40 may be made of, for example, iron. The number and arrangement (layout) of the power storage modules 10 are not limited to the above- described examples.

The four cross members 30 are arranged in the X direction at a distance from each other. Each of the four cross members 30 extends in the Y direction along three power storage modules 10 arranged in the Y direction.

The most X1-side cross member 30 of the four cross members 30 is provided between the side wall 21c and the power storage module 10. The most X2-side cross member 30 of the four cross members 30 is provided between the side wall 21d and the power storage module 10. The second cross member 30 from the X1 side of the four cross members 30 is provided between the power storage module 10 closest to the X1 side and the central power storage module 10 among the three power storage modules arranged in the X-direction. The second cross member 30 from the X2 side of the four cross members 30 is provided between the power storage module 10 closest to the X2 side and the central power storage module 10 among the three power storage modules arranged in the X- direction.

The cross member 30 disposed between the central power storage module 10 and X1-side power storage module 10 among the three power storage modules arranged in the X-direction is an exemplary “first partition member” of the present disclosure. The cross member 30 disposed between the central power storage module 10 and X2-side power storage module 10 among the three power storage modules 10 arranged in the X-direction is an exemplary “second partition member” of the present disclosure.

The six cross members 40 are provided so as to extend in the X direction between the power storage modules 10 adjacent to each other in the Y direction. Specifically, three sets of three power storage modules 10 arranged in the Y direction are provided in the case 20. The cross member 40 is provided between the power storage modules 10 adjacent to each other in the Y direction in each of the three sets.

Each of the plurality of coupling brackets 50 connects the three power storage modules 10 arranged in the Y direction. Each of the plurality of coupling brackets 50 extends in the Y direction along three power storage modules 10 arranged in the Y direction. The coupling brackets 50 are arranged on X1 and X2 sides of each of the sets (three sets) constituted by the three power storage modules 10 arranged in the Y-direction. The coupling bracket 50 may be made of aluminum, for example.

Each of the plurality of power storage modules 10 includes a fastening portion 11 fastened to the coupling bracket 50. The fastening portion 11 is provided so as to extend in the Y-direction at X1-side end and X2-side end of each of the plurality of power storage modules 10. The bolts 60 fasten Y1 and Y2 ends of the fastening portions 11 to the coupling brackets 50.

The coupling brackets 50 have a plurality of protrusions 51 protruding from the power storage module 10 toward the cross member 30 (X1 side or X2 side). Each of the plurality of protrusions 51 is provided above the cross member 30. The bolt 70 fastens the protrusion 51 overlapping in the Z direction and the portion of the cross member 30. Therefore, each power storage module 10 is fixed to the cross member 30 via the coupling bracket 50.

FIG. 3 is a cross-sectional view taken along III-III line of FIG. 2. The case 20 includes an upper cover 22. When the upper cover 22 is assembled to the lower case 21, a space in which the plurality of power storage modules 10 are accommodated is formed.

Each of the plurality of power storage modules 10 includes a lower module 1, an upper module 2, and a cooler 3. The lower module 1 is provided below the upper module 2. The cooler 3 is sandwiched between the lower module 1 and the upper module 2 in the Z direction. The lower module 1, the cooler 3, and the upper module 2 are stacked in this order from below.

The lower module 1 and the upper module 2 each include a cell case 4 and a cell case 5. Each of the cell case 4 and the cell case 5 houses a plurality of power storage cells 6. The cell case 4 and the cell case 5 have the same configuration.

A plurality of groove portions 21h recessed downward are formed on the bottom surface portion 21a of the lower case 21. The bottom surface portion 21a includes a flat surface portion 21i. That is, each of the plurality of groove portions 21h is formed so as to be recessed downward from the flat surface portion 21i. Each of the plurality of groove portions 21h is formed to extend in the X-direction. Two groove portions 21h are provided below each of the three power storage modules 10 arranged in the Y-direction. Note that the positions of the groove portions 21h in the Y direction are the same between the three power storage modules 10 arranged in the X direction (see FIG. 2). Further, since the groove portion 21h is formed, a raised portion (bead) 21k is formed on the outer surface 21j of the bottom surface portion 21a. Accordingly, the stiffness of the bottom surface portion 21a is improved. Note that the raised portion 21k may not be formed. Further, the groove portion 21h is an exemplary “concave portion” of the present disclosure.

The cross member 40 has a hat shape in a cross-sectional view along the Y direction. Specifically, the cross member 40 includes an upper end surface portion 41, a pair of side surface portions 42, and a pair of flange portions 43. The upper end surface portion 41 is formed so as to extend in the X direction. One and the other of the pair of side surface portions 42 are provided so as to extend downward from Y1 end portion and Y2 end portion of the upper end surface portion 41, respectively. One of the pair of flange portions 43 on Y1 side extends from the lower end portion of the side surface portion 42 toward Y1 side. One of the pair of flange portions 43 on Y2 side extends from the lower end portion of the side surface portion 42 toward Y2 side.

FIG. 4 is a cross-sectional view taken along IV-IV line of FIG. 2. A plurality of power storage cells 6 are arranged in the X direction inside each of the cell case 4 of the lower module 1 and the cell case 5 of the upper module 2. In FIG. 4, the coupling bracket 50 is not shown for the sake of simplicity.

The cell case 4 of the lower module 1 has a lower surface 4a. An exhaust hole 4b is formed on the lower surface 4a. The lower surface 4a is covered from below by the lower case 21 (bottom surface portion 21a). The cell case 5 of the upper module 2 has an upper surface 5a. An exhaust hole 5b is formed in the upper surface 5a. The number of the exhaust holes 4b and the exhaust holes 5b in the power storage modules 10 may be one or more. Further, the lower surface 4a is an exemplary “lower surface of the power storage module” of the present disclosure.

Here, in the conventional power storage device, when gas and smoke are discharged downward from the power storage module, foreign matter (debris) may be clogged between the lower case and the power storage module. In this case, the exhaust of the gas and the smoke from the power storage module is reduced by the foreign matter.

Therefore, in the present embodiment, a flue gas path 30a communicating with the groove portion 21h is formed inside the cross member 30. As a result, the gases and smoke discharged from the exhaust hole 4b flow along the groove portion 21h in the X- direction, and flow into the flue gas path 30a inside the cross member 30.

The gases and smoke flowing into the flue gas path 30a flow along the cross member 30 in the Y-direction, and are discharged to a gap between the power storage module 10 and the peripheral wall portion 21b (FIG. 2). The gases and smoke discharged into the gap move along the inner surface of the peripheral wall portion 21b to the relief valve 21g (FIG. 2) and are discharged from the relief valve 21g to the outside of the case 20. It should be noted that an exemplary flow path of the gas and the smoke moving along the flue gas path 30a is indicated by a dashed-dotted arrow in FIG. 2.

The cross member 30 has a hat shape in a cross-sectional view along the X direction. Specifically, the cross member 30 includes an upper end surface portion 31, a pair of side surface portions 32, and a pair of flange portions 33. The upper end surface portion 31 is formed to extend in the Y direction. One and the other of the pair of side surface portions 32 are provided so as to extend downward from X1-side end portion and X2-side end portion of the upper end surface portion 31, respectively. One of XI sides of the pair of flange portions 33 is provided so as to extend from the lower end of the side surface portion 32 to the X1 side. One of X2 sides of the pair of flange portions 33 is provided so as to extend to the X2 side from the lower end of the side surface portion 32. Each of the pair of flange portions 33 is provided at the lower end portion 34 of the cross member 30.

An opening 35 is formed in the lower end portion 34 of the cross member 30. The opening 35 is provided between the pair of flange portions 33. Therefore, the opening 35 is formed so as to extend in the Y direction along the pair of flange portions 33.

The cross member 30 is disposed above the groove portion 21h such that the opening 35 faces the groove portion 21h in the Z-direction. Specifically, the opening 35 of the cross member 30 is disposed at a position vertically overlapping at least one of X1- side end portion 211 (and the vicinity thereof) of the groove portion 21h and X2-side end portion 21m (and the vicinity thereof).

Specifically, the cross member 30 is provided at each position of the end portion 211 and the end portion 21m in the groove portion 21h below the central power storage module 10 among the three power storage modules 10 arranged in the X-direction. In addition, the cross member 30 is provided at a position on the end portion 211 of the groove portion 21h below X1-side power storage module 10 among the three power storage modules 10 arranged in the X-direction. In addition, the cross member 30 is provided at a position on the end portion 21m of the groove portion 21h below X2-side power storage module 10 among the three power storage modules 10 arranged in the X-direction.

The central power storage module 10 among the three power storage modules 10 arranged in the X-direction and the groove portion 21h below the central power storage module 10 are exemplary of the “first power storage module” and the “first groove portion”, respectively. The power storage module 10 disposed on the X1 side of the central power storage module 10 and the groove portion 21h below X1-side power storage module 10 are exemplary “second power storage module” and “second groove” of the present disclosure, respectively. The power storage module 10 disposed on the X2 side of the central power storage module 10 and the groove portion 21h below X2-side power storage module 10 are exemplary of the “third power storage module” and the “third groove”, respectively.

Groove portions 21h provided below each of the three power storage modules 10 arranged in the X-direction are separated from each other. Specifically, the bottom surface portion 21a (flat surface portion 21i) provided between the groove portions 21h adjacent to each other in the X-direction is contacted (welded) with the flange portion 33 of the cross member 30. In the contact portion, a seal portion 36 is formed. As a result, it is possible to suppress the gases and smoke from moving between the groove portions 21h adjacent to each other in the X-direction. In addition, it is possible to suppress the gases and smoke in the groove portion 21h being discharged to the side wall 21c or the side wall 21d.

FIG. 5 is a cross-sectional view taken along V-V line of FIG. 2. The power storage module 10 is provided such that the lower surface 4a of the lower module 1 is separated from the bottom surface portion 21a (flat surface portion 21i) of the lower case 21 while being fixed (indirectly) to the cross member 30 by the bolt 60 and the bolt 70. For example, the distance DI between the flat surface portion 21i and the lower surface 4a is larger than the thickness t of the plate member constituting the cross member 30. The distance DI may be larger than the distance D2 between the side surface portion 32 of the cross member 30 on the side of the power storage module 10 and the fastening portion 11a of the power storage module 10. The distance D2 may be larger than the thickness t.

The fastening portion 11 of the power storage module 10 includes a fastening portion 11a and a fastening portion 11b. The fastening portion 11a is provided in the lower module 1. The fastening portion 11b is provided in the upper module 2. The fastening portion 11b is provided above the fastening portion 11a.

A through-hole 11c penetrating in the Z-direction is formed in the fastening portion 11a. A through-hole 11d penetrating in the Z-direction is formed in the fastening portion 11b. The through-hole 11c and the through-hole 11c overlap each other in the Z- direction.

The coupling bracket 50 includes a non-protruding portion 52 provided continuously with the protrusion 51. The non-protruding portion 52 is vertically sandwiched between the fastening portion 11a and the fastening portion 11b. The non-protruding portion 52 is provided so as to extend in the Y direction. A through-hole 52a extending in the Z- direction is formed in the non-protruding portion 52. The through-hole 52a is threaded.

The bolt 60 includes a bolt 61 and a bolt 62. The bolt 61 has a head portion 61a and a shaft portion 61b extending Z1 from the head portion 61a. The bolt 62 has a head portion 62a and a shaft portion 62b extending Z2 from the head portion 62a. The shaft portion 61b of the bolt 61 passes through the through-hole 11c of the fastening portion 11a and is inserted into the through-hole 52a from below. The shaft portion 62b of the bolt 62 passes through the through-hole 11d of the fastening portion 11b and is inserted into the through-hole 52a from above. Thus, the power storage module 10 is fastened (fixed) to the coupling bracket 50.

The head portion 61a of the bolt 61 is fixed to the lower surface Ile of the fastening portion 11a. The head portion 62a of the bolt 62 is fixed to the upper surface 11f of the fastening portion 11b. The lower surface Ile of the fastening portion 11a is disposed above the lower surface 4a of the lower module 1. The upper surface 11f of the fastening portion 11b is arranged below the upper surface 5a of the upper module 2.

A through-hole 51a extending in the Z-direction is formed in the protrusion 51. The upper end surface portion 31 of the cross member 30 is formed with a through-hole 31a that penetrates the upper end surface portion 31 in the Z-direction. The bolt 70 has a head portion 71 and a shaft portion 72 extending Z2 from the head portion 71. The shaft portion 72 penetrates the through-hole 51a and the through-hole 31a. The head portion 71 is fixed to the upper surface 50a of the coupling brackets 50 (protrusions 51). The shaft portion 72 is fixed by a nut 51b. The nut 51b is fixed to the lower surface 31b of the upper end surface portion 31 of the cross member 30. Note that the nut 51b is an exemplary “fixing member” of the present disclosure.

In the power storage device 100 described above, the inside of the cross member 30 is formed with a flue gas path 30a that communicates with the downward recessed groove portion 21h formed on the bottom surface portion 21a of the lower case 21. As a result, the gases and smoke discharged downward from the power storage module 10 toward the lower case 21 can be guided to the flue gas path 30a of the cross member 30 by the groove portion 21h. As a consequence, the gas and smoke can easily flow into the flue gas path 30a in the cross member 30, so that the gas and smoke can be efficiently exhausted. As a consequence, it is possible to suppress foreign matters (debris) caused by gases and smoke being deposited on the bottom surface portion 21a of the lower case 21, and thus it is possible to suppress the foreign matters being exhausted. Accordingly, it is possible to suppress the case 20 or the power storage module 10 being damaged due to an increase in the internal pressure of the space between the power storage module 10 and the lower case 21.

In the above-described embodiment, the groove portion 21h extends in the X-direction, but the present disclosure is not limited thereto. The groove portion may extend in the Y direction.

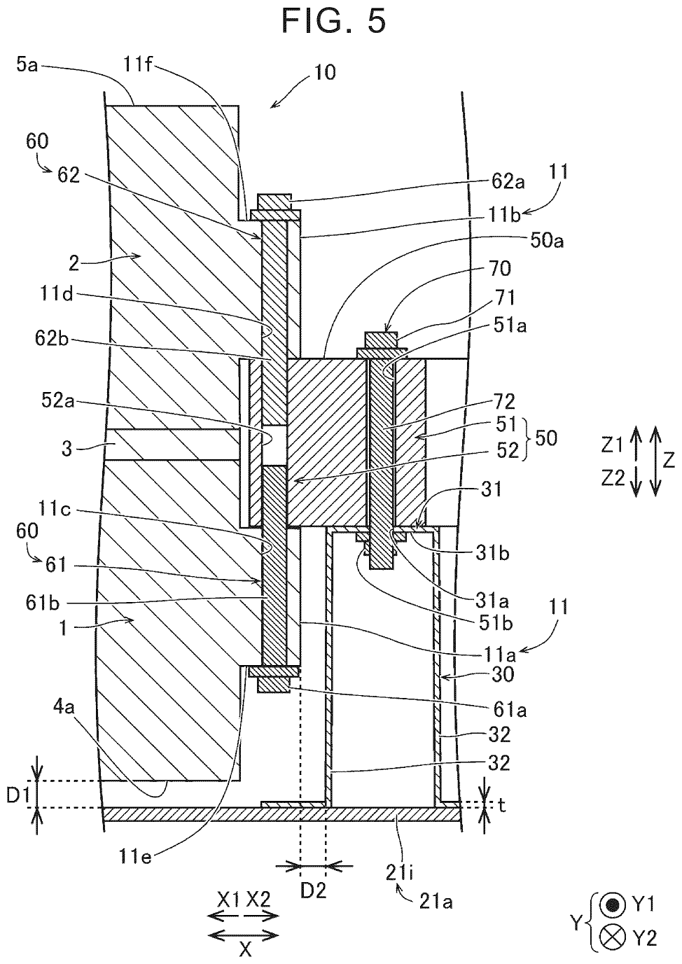

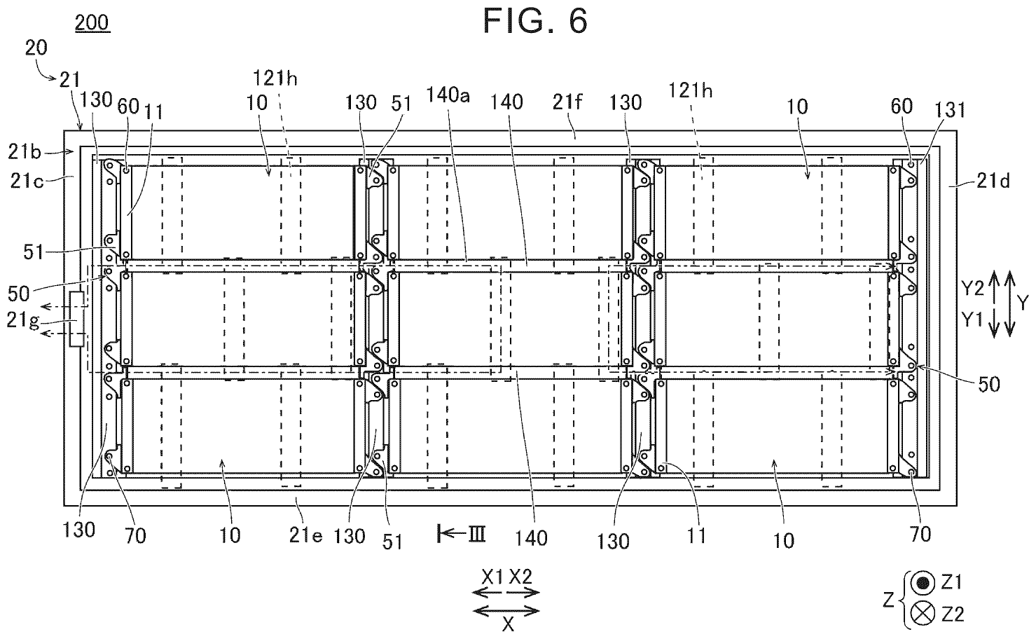

For example, in the power storage device 200 illustrated in FIG. 6, a groove portion 121h extending in the Y-direction is formed. Two groove portions 121h are formed below the respective power storage modules 10. Groove portions 121h provided below the power storage modules 10 adjacent to each other in the Y direction are formed at different positions in the X direction. Here, the groove portion 121h is an example of a “recess” of the present disclosure, and the Y direction is an example of an “arrangement direction” of the present disclosure. Further, among the configurations shown in FIG. 6, the same reference numerals as those in the above-described embodiment have the same configurations as those in the above-described embodiment, so that repetitive description will not be given.

The central power storage module 10 among the three power storage modules 10 arranged in the Y-direction and the groove portion 121h below the central power storage module 10 are exemplary “first power storage modules” and “first groove portions” of the present disclosure, respectively. The power storage module 10 disposed Y1 of the central power storage module 10 and the groove portion 121h below Y1 power storage module 10 are exemplary “second power storage module” and “second groove” of the present disclosure, respectively. The power storage module 10 disposed Y2 of the central power storage module 10 and the groove portion 121h below Y2 power storage module 10 are exemplary of the “third power storage module” and the “third groove”, respectively.

The power storage device 200 includes a plurality of (nine in FIG. 6) cross members 130, a cross member 131, and a plurality of (three in FIG. 6) cross members 140. Each of the plurality of cross members 130 is provided between the central power storage module 10 and X1-side power storage module 10 among the three power storage modules 10 arranged in the X-direction, between the central power storage module 10 and X2-side power storage module 10, and between X1-side power storage module 10 and the side wall 21c. The cross member 131 is provided between X2-side power storage module 10 and the side wall 21d. Each of the plurality of cross members 130 extends in the Y direction along the side surface of each of the power storage modules 10 in the X direction. The cross member 131 extends in the Y direction so as to straddle the three power storage modules 10 arranged in the Y direction. The cross member 140 is an example of a “partition member” of the present disclosure.

Each of the plurality of cross members 140 extends in the X direction so as to straddle three power storage modules 10 arranged in the X direction. The cross member 140 is disposed between the sets of the three power storage modules 10 arranged in the X direction. That is, the cross member 140 is disposed so as to cross (divide) between the cross members 130 adjacent to each other in the Y direction. Note that the shape (hat shape of the cross section) of each of the cross members 130 and 140 may be the same as that of the cross members 30 and 40 of the above-described embodiment.

The cross member 140 disposed between the central power storage module 10 and Y1 power storage module 10 among the three power storage modules arranged in the Y-direction is an exemplary “first partition member” of the present disclosure. The cross member 140 disposed between the central power storage module 10 and Y2 power storage module 10 among the three power storage modules arranged in the Y-direction is an exemplary “second partition member” of the present disclosure.

The groove portions 121h extend to an opening portion (not shown) provided at the lower end portion of the cross member 140. Specifically, in the central power storage module 10 among the three power storage modules 10 arranged in the Y-direction, the groove portion 121h extends to the opening of the cross member 140 provided on Y1 and Y2 sides of the power storage module 10. In the power storage module 10 on Y1 side among the three power storage modules 10 arranged in the Y direction, the groove portion 121h extends to the opening of the cross member 140 provided on Y2 side of the power storage module 10. In the power storage module 10 on Y2 side among the three power storage modules 10 arranged in the Y direction, the groove portion 121h extends to the opening of the cross member 140 provided on Y1 side of the power storage module 10.

As a result, the gases and smoke discharged from the power storage module 10 to the groove portion 121h flow into the flue gas path 140a in the cross member 140 through the opening portion of the cross member 140. Gas and smoke flowing into the flue gas path 140a in the cross member 140 travel through the flue gas path 140a of the cross member 140 to the relief valve 21g as indicated by the dashed-dotted arrow in FIG. 6, and are discharged from the relief valve 21g.

In addition, a part of the gases and smoke flowing into the flue gas path 140a in the cross member 140 flows toward the cross member 131 (X2 side), as indicated by the double-dashed arrow in FIG. 6. X2-side end of the cross member 140 contacts (abuts) the cross member 131. As a result, X2-side end portions of the cross members 140 are closed by the cross members 131. As a result, it is possible to suppress accumulation of foreign matter (debris) around the cross member 131 due to leakage of gas and smoke flowing toward the cross member 131 side from the cross member 140.

In the above embodiment, the lower surface 4a of the power storage module 10 is separated from the bottom surface portion 21a (the flat surface portion 21a) while being fixed to the cross member 30. The lower surface 4a of the power storage module 10 may be contacted with the flat surface portion 21a.

In the above-described embodiment, the groove portions 21h formed below the three power storage modules 10 arranged in the X direction have the same positions in the Y direction, but the present disclosure is not limited to this. The positions of the groove portions 21h in the Y direction may be different between the three power storage modules 10 (at least between the power storage modules 10 adjacent to each other in the X direction).

In the above-described embodiment, the groove portions 21h below the power storage modules 10 adjacent to each other in the X-direction are not connected to each other. The groove portion 21h may extend in the X direction so as to straddle the three power storage modules 10 arranged in the X direction.

In the above-described embodiment, the power storage module 10 includes the upper module 2 and the lower module 1, but the present disclosure is not limited thereto. The power storage module may not be divided into an upper module and a lower module.

In the above embodiment, the groove portion 21h is formed below the power storage module 10. A recess may be formed that does not have an elongated shape, such as a groove. In this case, a plurality of recesses may be formed below each of the power storage modules 10.

In the above embodiment, the power storage module 10 is indirectly fixed to the cross member 30 via the coupling bracket 50, but the present disclosure is not limited thereto. The power storage module 10 may be directly fixed (fastened) to the cross member 30.

Note that the configurations of the above-described embodiment and the above-described modification examples may be combined with each other.

It should be understood that the embodiments disclosed herein are illustrative and non-restrictive in all respects. The scope of the present disclosure is defined by the terms of the claims, rather than the description of the embodiments described above, and includes all modifications within the scope and meaning equivalent to the terms of the claims.

What is claimed is:

1. A power storage device comprising:
a power storage module including a lower surface with an exhaust hole;
a lower case including a bottom surface portion that covers the lower surface of the power storage module from below; and
a partition member provided on the lower case so as to partition a region in which the power storage module is disposed in the lower case, wherein:
the bottom surface portion is provided with a recessed portion recessed downward; and
a flue gas path that communicates with the recessed portion is provided inside the partition member.

2. The power storage device according to claim 1, wherein the partition member is configured to:
include a lower end portion provided with an opening portion that communicates with the flue gas path; and
be disposed above the recessed portion such that the opening portion faces the recessed portion in an up-down direction.

3. The power storage device according to claim 1, further comprising a fixing member that fixes the power storage module to the partition member, wherein the power storage module is provided such that the lower surface is separated from the bottom surface portion of the lower case in a state in which the power storage module is fixed to the partition member by the fixing member.

4. The power storage device according to claim 1, wherein:
the power storage module includes a first power storage module, a second power storage module, and a third power storage module arranged in an arrangement direction;
the second power storage module is disposed on one side in the arrangement direction with respect to the first power storage module;
the third power storage module is disposed on the other side in the arrangement direction with respect to the first power storage module;
the partition member includes
a first partition member provided between the first power storage module and the second power storage module so as to extend in an intersecting direction intersecting the arrangement direction, and
a second partition member provided between the first power storage module and the third power storage module so as to extend in the intersecting direction; and
the recessed portion includes a first groove portion provided to extend in the arrangement direction so as to connect the first partition member and the second partition member.

5. The power storage device according to claim 4, wherein:
the recessed portion further includes a second groove portion provided below the second power storage module so as to extend in the arrangement direction, and a third groove portion provided below the third power storage module so as to extend in the arrangement direction; and
the first groove portion is separated from the second groove portion and the third groove portion.
